(19) United States
(12) Patent Application Publication
(10) Pub. No.: US 2014/0139132 A1
(43) Pub. Date: May 22, 2014

(54) INSPECTING APPARATUS AND INSPECTING METHOD

(71) Applicant: Gyung-Kook KWAK, Yongin-City (KR)

(72) Inventor: Gyung-Kook KWAK, Yongin-City (KR)

(21) Appl. No.: 13/922,297

(22) Filed: Jun. 20, 2013

(30) Foreign Application Priority Data
Nov. 21, 2012 (KR) 10-2012-0132269

(51) Int. Cl. G09G 3/00

(52) U.S. Cl. CPC G09G 3/006
USPC 315/224; 315/307

(57) ABSTRACT

An inspecting apparatus includes a power supply unit that generates a power supply voltage and that outputs a generated power supply voltage, and a connecting unit for connecting to a connector of a display module. The connecting unit includes a first terminal from which the power supply voltage is output and a second terminal to which a feedback voltage is input from the display module, and the power supply unit controls the power supply voltage based on the feedback voltage.

### CROSS-REFERENCE TO RELATED APPLICATION

This application claims priority under 35 U.S.C. §119 to Korean Patent Application No. 10-2012-0132269, filed on Nov. 21, 2012, in the Korean Intellectual Property Office, the entire content of which is incorporated herein by reference.

### BACKGROUND

A display device, such as a liquid crystal display (LCD) and an organic light emitting display, may display gray scale images in accordance with a predetermined gamma set.

### SUMMARY

Embodiments may be realized by providing an inspecting apparatus that includes a power supply unit that generates a power supply voltage and that outputs a generated power supply voltage, and a connecting unit for connecting to a connector of a display module. The connecting unit includes a first terminal from which the power supply voltage is output and a second terminal to which a feedback voltage is input from the display module. The power supply unit controls the power supply voltage based on the feedback voltage.

The first and second terminals may be electrically connected to each other through the display module. The power supply unit may include a DC-DC converter that converts an input voltage to generate the power supply voltage, and a controller that controls the DC-DC converter based on the power supply voltage and the feedback voltage.

The controller may include a comparing unit that outputs a difference between the power supply voltage and the feedback voltage, and a pulse width modulation (PWM) signal generator that generates a PWM signal for controlling the DC-DC converter based on the difference.

Embodiments may also be realized by providing an inspecting method that includes connecting a display module, supplying a power supply voltage to the display module, receiving a feedback voltage from the display module, compensating for the power supply voltage based on the feedback voltage to generate a compensated power supply voltage, and supplying the compensated power supply voltage to the display module.

The feedback voltage may be a voltage based on the power supply voltage that is received via a connector of the display module. Compensating for the power supply voltage may include obtaining a difference between the power supply voltage and the feedback voltage, and controlling a voltage level of the power supply voltage based on the difference. In controlling the power supply voltage, the power supply voltage may be increased by half the difference.

### BRIEF DESCRIPTION OF THE DRAWINGS

The accompanying drawings, together with the specification, illustrate exemplary embodiments, and, together with the description, serve to explain the principles of the embodiments.

FIG. 1 illustrates an inspecting apparatus connected to a display module to be inspected, according to an exemplary embodiment;

FIG. 2 illustrates an embodiment of the controller illustrated in FIG. 1;

FIG. 3 illustrates an inspecting method according to an exemplary embodiment; and

FIG. 4 illustrates an embodiment of compensating for a power supply voltage.

### DETAILED DESCRIPTION

Korean Patent Application No. 10-2012-0132269, filed on Nov. 21, 2012, in the Korean Intellectual Property Office, and entitled: “Inspecting Apparatus and Method Thereof” is incorporated by reference herein in its entirety.

Detailed items of the other embodiments are included in detailed description and drawings. The advantages and characteristics and a method of achieving the advantages and characteristics now will be described more fully with reference to the accompanying drawings, in which exemplary embodiments are shown. Embodiments, may, however, be embodied in many different forms and should not be construed as being limited to the embodiments set forth herein. In the drawings, when a part is connected to another part, the part may be directly connected to the other part and the part may be electrically connected to the other part with another element interposed. In the drawings, the part that is not related to the present invention is omitted for clarity of description. The same reference numerals in different drawings represent the same element, and thus their description will be omitted.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the exemplary implementations to those skilled in the art.

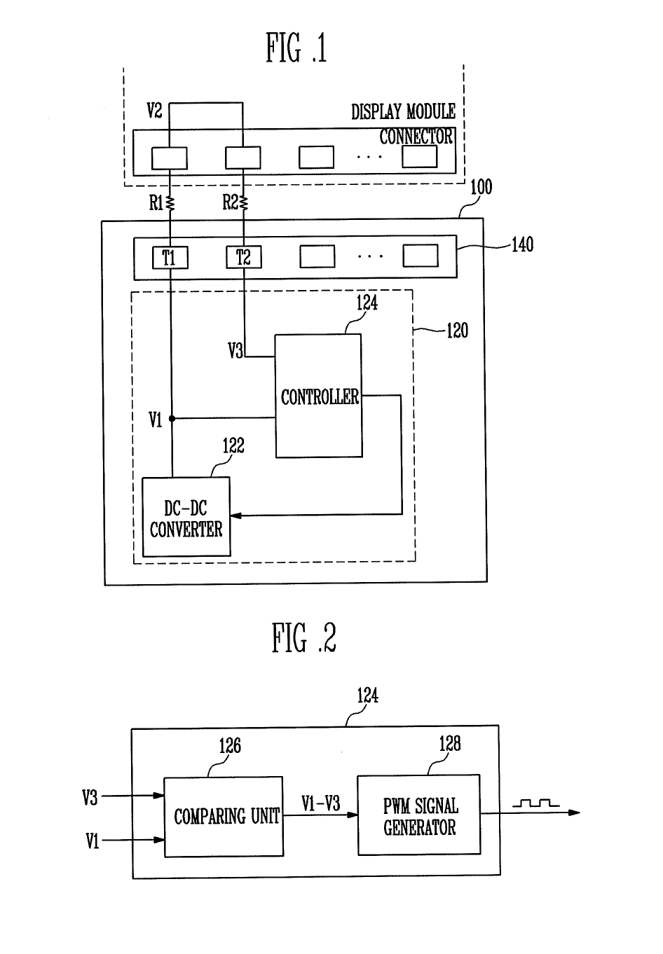

FIG. 1 illustrates an inspecting apparatus according to an embodiment connected to a display module to be inspected.

Referring to FIG. 1, an inspecting apparatus 100 includes a power supply unit 120 and a connecting unit 140.

The inspecting apparatus 100 supplies a power supply voltage and various control signals to the display module and may check whether the display module normally operates and/or may perform multi time programming (MTP) for setting gamma of the display module.

The power supply unit 120 generates a power supply voltage V1 to be supplied to the display module.

The connecting unit 140 may be connected to a connector of the display module to transmit the power supply voltage V1, generated by the power supply unit 120, to the display module. The connecting unit 140 may receive a feedback voltage V3 input from the display module and may transmit the received feedback voltage V3 to the power supply unit 120. For this purpose, the connecting unit 140 may include a first terminal T1 for outputting the power supply voltage V1 to the display module, and may include a second terminal T2 for receiving the feedback voltage V3 from the display module. The power supply voltage V1 generated by the power supply unit 120 may be provided to the display module through the first terminal T1 of the connecting unit 140. A voltage V2 output from the display module may be provided to the power supply unit 120 through the second terminal T2 of the connecting unit 140.

The first terminal T1 and the second terminal T2 may be electrically connected through the display module, which is connected to the connecting unit 140.

For example, the first terminal T1 and the second terminal T2 may be electrically connected to each other through a printed circuit board (PCB) wiring line of the display module or by short of the corresponding terminals of the connector of the display module.

The connecting unit 140 may include a plurality of the first terminal T1 for outputting the power supply voltage V1. In addition, the connecting unit 140 may include a plurality of the second terminal T2 for receiving the feedback voltage V3. The terminals T1 and T2 of the connecting unit 140 may include pogo pins, and contact between the terminals and the connector of the display module may be supported by elasticity of the pogo pins.

Hereinafter, the operation of the inspecting apparatus 100 according to an embodiment will be described.

When the display module and the inspecting apparatus 100 are connected to each other, resistance in accordance with contact between the connector of the display module and the connecting unit 140 of the inspecting apparatus 100 exists. The resistance may be negligible or may have a meaningful value to be considered. The resistance may vary with the material of a contact part between the connecting unit 140 and the connector of the display module, and with a contact state between the connecting unit 140 and the connector of the display module. For example, first resistance R1 generated by contact between the first terminal T1 of the connecting unit 140 and the corresponding terminals of the connector may exist, and second resistance R2 generated by contact between the second terminal T2 of the connecting unit 140 and the corresponding terminals of the connector may exist.

Since the power supply voltage V1 is transmitted through the first terminal T1, as the first resistance R1 increases, the operation voltage V2 transmitted to the display module is reduced. When the operation voltage V2 provided to the display module does not reach a target level, e.g., as a result of inspection a normal product may be determined to be defective or a defective product may be determined to be normal. Further, MTP for setting the gamma of the display module may be performed in the state where the operation voltage V2, which is at a lower level that the target level, is applied so that the brightness of the display module may be increased.

The inspecting apparatus 100 may be configured to provide the operation voltage V2 in the target level sought for the display module to normally operate in spite of the first resistance R1.

First, the power supply unit 120 generates the power supply voltage V1 to supply the generated power supply voltage V1 to the display module. The power supply voltage V1 is dropped by the first resistance R1 to be provided to the display module as the operation voltage V2. Then, the operation voltage V2 is fed back to the inspecting apparatus 100, during which the operation voltage V2 is dropped by the second resistance R2 to be provided to the power supply unit 120 of the inspecting apparatus 100 as the feedback voltage V3. The power supply unit 120 controls the power supply voltage V1 based on the feedback voltage V3. For example, the inspecting apparatus 100 generates the power supply voltage V1 in consideration of the voltage drop in accordance with the first resistance R1. The power supply unit 120 may control the level of the power supply voltage V1 while monitoring the feedback voltage V3 in real time.

The power supply unit 120 may include a DC-DC converter 122 and a controller 124.

The DC-DC converter 122 converts a DC input voltage to generate the power supply voltage V1. The DC-DC converter 122 may be a switching regulator that operates in response to a pulse width modulation (PWM) signal having a period. The DC-DC converter 122 may include at least one of a boost converter for boosting the input voltage and a buck-boost converter for inverting the polarity of the input voltage.

The controller 124 controls the DC-DC converter 122 based on the power supply voltage V1 and the feedback voltage V3. For example, the controller 124 controls the DC-DC converter 122 to detect the voltage drop caused by connection between the connecting unit 140 and the connector of the display module and to output the power supply voltage V1 that compensates for the voltage drop.

The controller 124 monitors the power supply voltage V1 and the feedback voltage V3 in real time to control the power supply voltage V1 so that the operation voltage V2 maintains the target level when the operation voltage V2 applied to the display module deviates from the target level.

FIG. 2 illustrates an embodiment of the controller illustrated in FIG. 1.

Referring to FIG. 2, the controller 124 includes a comparing unit 126 and a PWM signal generator 128.

The comparing unit 124 compares the power supply voltage V1 with the feedback voltage V3 to output a difference value V1-V3.

The PWM signal generating unit 128 generates a PWM signal for controlling the DC-DC converter 122 based on the difference value V1-V3. The difference value V1-V3 includes information on a voltage drop component generated by the first resistance R1 and a voltage drop component generated by the second resistance R2. Therefore, the PWM signal generator 128 monitors the difference value V1-V3 to confirm whether the operation voltage V2 that operates the display module corresponds to the target level.

For example, when the power supply voltage V1 output from the DC-DC converter 122 is 4.6 V and the difference value V1-V3 between the power supply voltage V1 and the feedback voltage V3 is 0.4 V, the PWM signal generator 128 controls the power supply voltage V1 to increase the power supply voltage V1 by 0.2 V, which is half the difference value V1-V3 because the first resistance R1 may commonly be substantially the same as the second resistance R2. As a result, the DC-DC converter 122 outputs the controlled power supply voltage V1 of 4.62 V and the operation voltage V2 of the display module may be 4.6 V, which may correspond to the target level.

The inspecting apparatus 100 according to an embodiment may provide the operation voltage V2 in the target level required for the display module to normally operate in spite of the first resistance R1. Therefore, it is possible to reduce fraction defective generated by MTP performed in the state where the operation voltage V2 does not reach the target level due to the resistance generated by the connection between the display module and the inspecting apparatus 100.

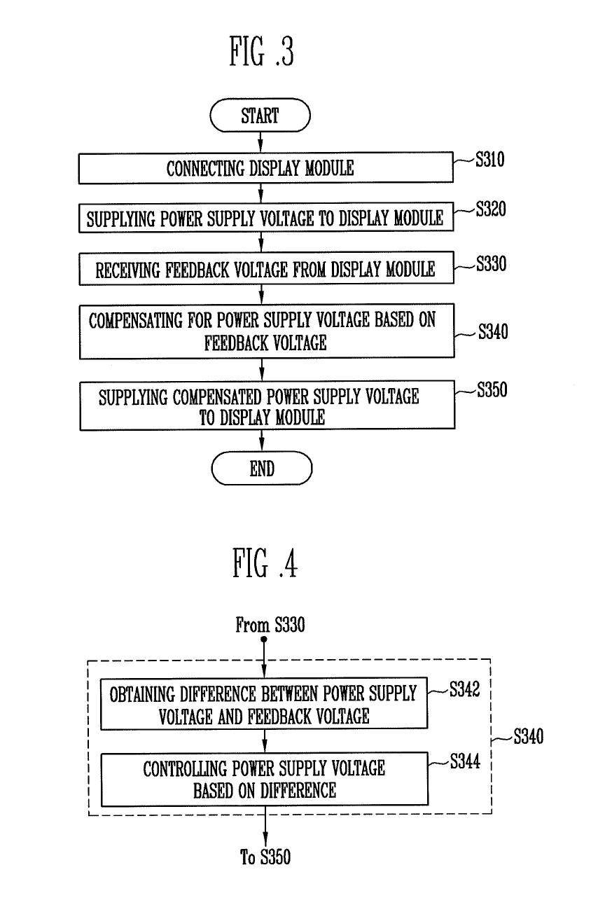

FIG. 3 illustrates an inspecting method according to another embodiment. Referring to FIG. 3, the inspecting method may include connecting a display module (operation S310), supplying a power supply voltage to the display module (operation S320), receiving a feedback voltage from the display module (operation S330), compensating for the power supply voltage based on the feedback voltage (operation S340), and supplying the compensated power supply voltage to the display module (operation S350).

For example, in connecting the display module in operation S310, the connector of the display module is connected to the connecting unit 140 of the inspecting apparatus 100. Resistance in accordance with contact between the connector of the display module and the connecting unit 140 of the inspecting apparatus 100 may exist. The resistance may vary with the material of a contact part between the connecting unit 140 and the connector of the display module, and with a contact state between the connecting unit 140 and the connector of the display module.

The inspecting apparatus 100 may supply the power supply voltage V1 and various control signals to the display module, may check whether the display module normally operates, and/or may perform MTP for setting the gamma of the display module. The inspecting apparatus may be the inspecting apparatus 100 illustrated in FIG. 1,

In supplying the power supply voltage V1 to the display module in operation S320, a voltage required for operating the display module is provided.

In receiving a feedback voltage V3 from the display module in operation S330, the power supply voltage V1 is fed back to receive a voltage output from the display module, e.g., operation voltage V2. The feedback voltage V3 may include a voltage drop component generated by contact between the connector of the display module and the connecting unit 140 of the inspecting apparatus 100. For example, the feedback voltage V3 may be a voltage at which the power supply voltage V1 is fed back to the inspecting apparatus 100 by the PCB wiring line of the display module. The feedback voltage V3 may be realized by the voltage at which the power supply voltage V1 is fed back from the connector of the display module to the inspecting apparatus 100.

In compensating for the power supply voltage V1 based on the feedback voltage V3 in operation S340, the feedback voltage V3 is monitored, e.g., in real time, to grasp to which degree the voltage drop is caused by contact between the connector of the display module and the connecting unit 140 of the inspecting apparatus 100.

In supplying the power supply voltage V1 that compensates for the voltage drop, e.g., in supplying the compensated power supply voltage V1 in real time, to the display module in operation 5350, the power supply voltage whose level is increased is generated. For example, the compensated power supply voltage V1 to be supplied to the display module is generated in consideration of the voltage drop caused by the contact between the connector of the display module and the connecting unit 140 of the inspecting apparatus 100.

FIG. 4 illustrates an embodiment of compensating for a power supply voltage of FIG. 3. Referring to FIG. 4, compensating for voltage drop in the power supply voltage V1 in operation 5340 includes calculating a difference between the power supply voltage V1 and the feedback voltage V3 in operation 5342 and controlling the power supply voltage V1 based on the calculated difference in operation 5344. Both operation S342 and operation S344 may be performed in real time.

In calculating the difference between the power supply voltage V1 and the feedback voltage V3 in operation S342, the difference between the power supply voltage V1 supplied to the display module and the feedback voltage input from the display module is calculated. The difference value includes information on the voltage drop caused by contact between the connector of the display module and the connecting unit 140 of the inspecting apparatus 100. For example, when one contact part that transmits the power supply voltage V1 and one contact part that transmits the feedback voltage V3 exist, the difference value may represent a total amount of voltage drop in the two contact parts.

In controlling the power supply voltage V1 based on the difference in operation S344, the voltage level of the power supply voltage V1 is controlled by the amount grasped by the voltage drop information. For example, when one contact part that transmits the power supply voltage V1 and one contact part that transmits the feedback voltage V3 exist, the power supply voltage V1 is increased by half the difference between the power supply voltage V1 and the feedback voltage V3 because the amount of the voltage drop in accordance with the resistance in the two contact parts may be the same or substantially similar. Since the operation voltage V2 is obtained by subtracting the amount of the voltage drop in the contact part that transmits the power supply voltage V1 from the power supply unit 120, the power supply voltage V1 is to be increased by half the difference value.

By summation and review, setting gamma may be referred to as defining a correlation between brightness and gray scale data, e.g., that is a gamma curve. Gamma is commonly set to vary with a manufacturing company or a model in accordance with the characteristic of a display panel being used. Further, it may be sought to set the gamma of the display device in accordance with the requirements of a customer before forwarding the display device to the customer.

The gamma may be set by a multi time programming (MTP) method, and MTP may be performed for setting the display device to have the gamma characteristic desired by the customer before forwarding the display device. In order to perform MTP, a display module is connected to an inspecting apparatus. Due to a resistance component generated by the connection between the display module and the inspecting apparatus, MTP may be performed in the state where a power supply voltage ELVDD is dropped, e.g., is less than a target voltage. In this case, the gamma characteristics may not be properly set so that, e.g., the brightness of the display module may be increased, the gamma of the display device may not be in line with the requirements of the customer.

In the case of the organic light emitting display, when the power supply voltage ELVDD applied to the anode terminal of an organic light emitting diode (OLED) to supply current varies, brightness in accordance with gray scale data varies. Therefore, in performing MTP, when the power supply voltage ELVDD does not reach a target voltage level, the gamma may not be successfully set. Therefore, when MTP is performed in such a manner, in spite of contact resistance, the power supply voltage ELVDD should be normally supplied to the display module.

Accordingly, embodiments relate to an inspecting apparatus and an inspecting method capable of providing a power supply voltage at which a display module may normally operate in spite of a bad connection, e.g., high contact resistance, between the display module and the inspecting apparatus. For example, embodiments relate to an apparatus for inspecting a display panel capable of compensating for a voltage drop caused by bad connection between the inspecting apparatus and the display module to provide a normal operation voltage to the display module. Further, according to embodiments, it is possible to provide the inspecting apparatus and the inspecting method capable of compensating for a voltage drop caused by the bad connection between the inspecting apparatus and the display module to provide the power supply voltage at which the display module may normally operate.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An inspecting apparatus, comprising:
a power supply unit that generates a power supply voltage and that outputs a generated power supply voltage; and
a connecting unit for connecting to a connector of a display module, the connecting unit including a first terminal from which the power supply voltage is output and a second terminal to which a feedback voltage is input from the display module,
wherein the power supply unit controls the power supply voltage based on the feedback voltage.

2. The inspecting apparatus as claimed in claim 1, wherein the first and second terminals are electrically connected to each other through the display module.

3. The inspecting apparatus as claimed in claim 2, wherein the power supply unit includes:
a DC-DC converter that converts an input voltage to generate the power supply voltage, and
a controller that controls the DC-DC converter based on the power supply voltage and the feedback voltage.

4. The inspecting apparatus as claimed in claim 3, wherein the controller includes:
a comparing unit that outputs a difference between the power supply voltage and the feedback voltage, and
a pulse width modulation (PWM) signal generator that generates a PWM signal for controlling the DC-DC converter based on the difference.

5. An inspecting method, comprising:
connecting a display module;
supplying a power supply voltage to the display module;
receiving a feedback voltage from the display module;
compensating for the power supply voltage based on the feedback voltage to generate a compensated power supply voltage; and
supplying the compensated power supply voltage to the display module.

6. The inspecting method as claimed in claim 5, wherein the feedback voltage is a voltage based on the power supply voltage that is received via a connector of the display module.

7. The inspecting method as claimed in claim 6, wherein compensating for the power supply voltage includes:
obtaining a difference between the power supply voltage and the feedback voltage, and
controlling a voltage level of the power supply voltage based on the difference.

8. The inspecting method as claimed in claim 7, wherein, in controlling the power supply voltage, the power supply voltage is increased by half the difference.
